(19) United States
(12) Patent Application Publication
(10) Pub. No.: US 2007/0092017 A1
(43) Pub. Date: Apr. 26, 2007

(54) Communications systems and methods using phase vectors

(75) Inventor: Saied Abedi, Reading (GB)

Correspondence Address: BINGHAM MCCUTCHEN LLP, 3000 K STREET, NW, BOX IP, WASHINGTON, DC, 20007, US

(73) Assignee: FUJITSU LIMITED

(21) Appl. No.: 11/585,232

(22) Filed: Oct. 24, 2006

(30) Foreign Application Priority Data
Oct. 25, 2005 (EP) 05256600.7

(51) Int. Cl. H04K 1/10

(52) U.S. Cl. 375/260

(57) ABSTRACT

A transmitter for use, for example, in an OFDM communication system transmits a plurality of signals simultaneously to one or more receivers. Each signal carries data. At the transmitter, a suitable phase vector is selected from among a plurality of available phase vectors to apply to the plurality of signals. Each available phase vector comprises a plurality of phase elements each of which corresponds to one or more of said signals and sets a phase adjustment to be applied by the transmitter to the corresponding signal(s). The suitability of each available phase vector may be judged based on a peak-to-average power ratio reduction achievable by applying the phase vector concerned to the plurality of signals. The selection of the suitable phase vector is initially limited to phase vectors belonging to a first set of the available phase vectors, and is expanded to further phase vectors outside said first set when no suitable phase vector is found in the first set. This can save processing burden in the transmitter.

### BACKGROUND OF THE INVENTION

1. Field of the Invention

The present invention relates to communication systems and methods in which a transmitter transmits a plurality of signals simultaneously to one or more receivers, and selects a phase vector from among a set of available phase vectors to apply to the plurality of signals. The present invention is applicable, for example, to orthogonal frequency division multiplexing (OFDM) communication systems and methods.

2. Background of the Prior Art

In an OFDM communication system a plurality N of sub-carriers are employed to carry data from a transmitter to one or more receivers. The number N of sub-carriers may be relatively large, for example N=512. One problem which arises in OFDM communication systems is that a peak-to-average power ratio (hereinafter PAPR) tends to be high. The peak power increases generally according to the number of sub-carriers. When the PAPR is high, an amplifier having a very wide dynamic range is required in the transmitter, which is undesirable.

Numerous techniques have been proposed to solve the problems with PAPR in OFDM communication systems.

For example, a back-off technique has been proposed for use in a high-power linear amplifier in the transmitter. The back-off technique allows the multicarrier signal to be maintained within a linear range by lowering an input power to the amplifier. This has the effect of lowering the operation point of the high-power linear amplifier in order to reduce distortion of the signal. However, the greater the extent of the back-off, the less efficient the utilisation of the amplifier becomes. Accordingly, a signal having a high PAPR may cause the efficiency of the linear amplifier to deteriorate.

Another technique which has been proposed to cause the multicarrier signal to have an amplitude within a linear operating range of the amplifier is a clipping technique. In this technique, when the amplitude of the signal exceeds a predetermined reference clipping value set in advance, a portion of the amplitude of the signal exceeding the reference clipping value is removed or clipped out. However, in the clipping technique, non-linear operation may cause in-band distortion, thereby increasing inter-symbol interference and bit error rate. Furthermore, in the clipping technique, out-of-band noise may cause channel interference, thereby causing the spectrum efficiency to deteriorate.

In a block coding technique, additional subcarriers are provided which are coded and transmitted in such a way as to lower the PAPR of the overall set of subcarriers, i.e. the subcarriers used for transmission of data and the additional subcarriers used for block coding. In this technique, the coding of the additional subcarriers achieves the correction or errors and the reduction of the PAPR without distortion of the signal. However, when subcarriers have large amplitudes, this technique provides very poor spectrum efficiency and requires a large look-up table or a large generation matrix, increasing the processing required at the transmitter.

In a tone reservation (TR) technique, some subcarriers from among the entire set of available subcarriers are reserved for PAPR reduction. The reserved carriers carry no data. The receiver simply disregards the subcarriers which carry no data and recovers the data from the remaining subcarriers. This can enable the receiver to have a simpler construction.

A gradient algorithm has also been proposed, which is an application of the clipping technique to the TR technique. In this case, signals having an impulse characteristic are generated using the subcarriers that carry no data, and inverse fast fourier transform (IFFT) output signals are clipped using the signals having the impulse characteristic. When the generated signals having an impulse characteristic are added to the IFFT output signals, data distortion occurs only in some subcarriers carrying no data and does not occur in the other subcarriers carrying data.

An analog coding technique is also possible. Clipping of the high amplitudes caused by analog circuitry leads to additional noise. In principle, it has been shown that so-called analog codes (Reed-Solomon codes over complex numbers) may be used for eliminating this noise.

Phase adjustment techniques have also been proposed for solving the PAPR problem. The phase adjustment techniques include a partial transmit sequence (PTS) method and a selective mapping (SLM) method.

In the PTS method, input data is divided into M sub-blocks, each of the M sub-blocks is subjected to L-point IFFT and is then multiplied by a phase factor for minimising the PAPR. Finally, the M sub-blocks are summed and transmitted.

In the SLM method, a given block of data which will constitute one OFDM symbol is multiplied by U (U>1) different available phase vectors. Each available phase vector comprises N phase elements, each corresponding individually to one of the N subcarriers. Each phase element sets a phase adjustment to be applied by the transmitter to the corresponding subcarrier for the data block concerned. The effect of this is to generate U statistically dependent “candidate” OFDM symbols for the given data block. The transmitter selects that one of the candidate symbols having the lowest PAPR and transmits the selected symbol to the receiver or receivers. Herein, the phase vector which was used to produce the selected symbol is referred to as the selected phase vector ũ.

FIG. 1 of the accompanying drawings shows parts of an OFDM communication system employing the SLM method.

The communication system of FIG. 1 comprises a transmitter 10 and a receiver 20. The transmitter 10 includes an available phase vector storage unit 12, a phase vector selection unit 14 and a transmission unit 16. The available phase vector storage unit 12 stores data relating to U available phase vectors. Each phase vector is made up of N phase elements φ₀, φ₁, φ₂, . . . , φ_{N-1}. Thus,
Pᵤ=[e^{jφ}^{₀}^{u},e^{jφ}^{₁}^{u}, . . . ,e^{jφ}^{_{N−1}}^{u} (1)
assuming that Φₙ^{u}∈(0,2π], u∈{1, . . . ,U}

The phase vector selection unit 14 has access to the stored available phase vectors and also receives a block C of input data which is to be transmitted by the transmitter 10 to the receiver 20 in a particular transmission time interval (TTI). As is well known in the art, an OFDM symbol is made up of a block of N modulation symbols, and each of the N modulation symbols is transmitted using one of N orthogonal subcarriers. The adjacent subcarrier separation Δf=1/T, where T is the OFDM signal duration (TTI duration). The resulting multicarrier signal may be expressed as

$$s ( t ) = \frac{1}{\sqrt{N}} {\sum }_{n = 0}^{N - 1} {c}_{n} {ⅇ}^{j 2 πΔ f t} , \\ 0 \leq t \leq T \qquad ( 2 )$$

where C=(c₀ c₁ . . . c_{N-1}) represents a vector of N constellation symbols from a constellation. For the signal s(t) the PAPR is given by:

$$ξ = \frac{max \vert s ( t ) \vert}{E \{ {\vert s ( t ) \vert}^{2} \}} \qquad ( 3 )$$

where E denotes expectation.

The phase vector selection unit 14 calculates the vector product of the input data vector C and each of the available phase vectors Pᵤ to produce U candidate OFDM symbols. The candidate symbol
C⊕P_{ũ}, ũ∈{1, . . . ,U}
which has the lowest PAPR is then selected for transmission by the transmission unit 16. Accordingly, each modulated signal sᵢ carries a modulation symbol cᵢ and has a phase adjustment φₙ^{ũ} on set by the selected phase vector ũ.

At the receiver 20 the received signal after FFT demodulation can be expressed as
rₙ=Hₙcₙe^{jφ}^{ₙ}^{ũ}+nₙ (4)
where Hₙ represents the frequency response of the fading channel of the n-th subcarrier and nₙ represents complex additive white Gaussian noise (AWGN).

The receiver comprises a receiving unit 22 which effectively reverses the phase adjustments applied at the transmitter to the selected OFDM symbol. As is clear from equation (4), to recover the data from the received signal the term e^{jφ}^{ₙ}^{ũ} is required. Accordingly, the identity ũ of the selected phase vector is required by the receiver 20.

In view of the receiver's requirement to know ũ, the transmitter 10 may transmit the identify ũ of the selected phase vector for each OFDM symbol to the receiver. However, this requires at least log₂(ũ) bits. For example, if U=256, then 8 signalling bits are required. This constitutes an unacceptable signalling overhead in a practical OFDM system.

To avoid the signalling overhead associated with the transmission of the identity ũ of the selected phase vector, a blind SLM receiver has been proposed in “A blind SLM receiver for PAR-reduced OFDM”, A. D. S. Jayalath and C Tellambura, Proceedings of IEEE Vehicular Technology Conference, pp 218-222, Vancouver, Canada, 24 to 28 Sep. 2002. The blind SLM receiver works on the basis that (1) cₙ's are restricted to a given signal constellation, for example QPSK, (2) the set of available phase vectors is fixed and known to the receiver, and (3) c⊕ Pᵤ and c⊕ Pᵥ are sufficiently different for u≠v. In other words, the set of available phase vectors have large Hamming distances, providing inherent diversity which can be exploited at the receiver. The necessary condition for the blind receiver to work is
cₙe^{jφ}^{ₙ}^{u}∉Q for all n and u

The set of available phase vectors can be readily chosen to ensure this.

Assuming a distortionless and noiseless channel, the blind SLM receiver receives the OFDM symbol ƒ_{ũ}(c) determined by the transmitter as having the minimum PAPR. The receiver computes
ƒⱼ⁻¹(ƒ_{ũ}(c)) for j=1, 2, . . . , U
Because of the three assumptions mentioned above, ƒⱼ⁻¹(ƒ_{ũ}(c)) will not be a valid vector of symbols from the constellation φ of the selected modulation scheme unless j=ũ.

The optimal decision metric for the blind SLM receiver is

$$D = {min}_{{[ {\hat{c}}_{0} , {\hat{c}}_{1} , … , {\hat{c}}_{N - 1} ]}_{{P}_{\hat{u}} , \hat{u} ∈ \{ 1 , … , U \}}} {\sum }_{n = 0}^{N - 1} {\vert {r}_{n} {ⅇ}^{- {jϕ}_{n}^{\hat{u}}} - {H}_{n} {\hat{c}}_{n} \vert}^{2} \qquad ( 5 )$$

to carry out this miniaturisation, the minimum-distance H⊕ĉ to r⊕P₀* is determined, where P₀* is the conjugate of P₀ This can be done by using the Viterbi algorithm in the case of a coded system or by searching all q^{N} data sequences in the case of uncoded q-ary modulation. This minimum-distance determination is repeated for each one of the available phase vectors. The global minimum-distance-solution yields the best estimates for c and ũ. In the case of a coded system, the overall complexity is U times that of a system without SLM.

In an uncoded system, equation (5) can only be solved by carrying out the |·|² operation UN4^{N} times. This is of very high complexity and is only feasible when N is relatively small.
Jayalath and Tellambura disclosed in the above-mentioned paper a simplified decision metric having a lower complexity than the metric of equation (5):

$${D}_{SLM} = {min}_{{P}_{\hat{u}} , \hat{u} ∈ \{ 1 , 2 , … , U \}} {\sum }_{n = 0}^{N - 1} {min}_{{\hat{c}}_{n} ∈ Q} {\vert {r}_{n} {ⅇ}^{- {jϕ}_{n}^{\hat{u}}} - {H}_{n} {\hat{c}}_{n} \vert}^{2} \qquad ( 6 )$$

FIG. 2 of the accompanying drawings shows parts of a blind SLM receiver 30 employing the simplified decision metric. The blind SLM receiver 30 of FIG. 2 comprises an N-point DFT unit 32 which receives a baseband signal and carries out DFT demodulation to obtain a received signal rₙ. The receiver 30 also comprises a channel estimation unit 34 which derives from the received signal an estimate Ĥₙ of the channel of the n-th subcarrier. The receiver 30 knows the U available phase vectors P₁ to P_{U} and comprises U vector multipliers 36₁ to 36_{U} corresponding respectively to the U available phase vectors P₁ to P_{U}. Each vector multiplier 36ᵢ receives the received signal rₙ and the complex conjugate Pᵢ* of its corresponding phase vector Pᵢ and multiplies the received signal and the complex conjugate together to produce r⊕ Pᵢ*. The receiver 30 also comprises U processing units 38₁ to 38_{U} corresponding respectively to the U available phase vectors. Each processing unit 38ᵢ calculates the minimum-distance H⊕c to R⊕Pᵢ* for its corresponding phase vector Pᵢ. rₙ is detected into the nearest constellation point cₙ by comparing rₙ with Hₙcₙe^{jφ}^{ₙ}^{ũ} Thus, a hard decision is made for each subcarrier. For example, in a coded OFDM system having a given trellis structure, the Viterbi algorithm can be used in each processing unit 38ᵢ.

After calculating the minimum distance for each of the available phase vectors, the respective minimum distances for the phase vectors are applied to a selection unit 40 which identifies the phase vector which provides the minimum Euclidian distance solution. The selection unit 40 outputs the minimum Euclidian distance solution as the detected data symbol cₙ.

The simplified decision metric adopted in the blind SLM receiver of FIG. 2 has the advantage that the number of |·|² operations in equation (6) to be performed by the receiver is qUN, where q denotes q-ary modulation. For example, in the case of QPSK modulation, q=4. Thus, the FIG. 2 receiver is effective in achieving some degree of processing simplification on the receiver side, as well as avoiding the signalling overhead associated with transmitting the identity ũ of the selected phase vector from the transmitter to the receiver.

However, the FIG. 2 receiver is still considered impractical in the case in which higher-order modulation schemes such as 16QAM and 64QAM are required and/or when the number of available phase vectors is increased. Generally, the higher the number of phase vectors that are available, the greater the PAPR reduction that can be achieved. Furthermore, the transmitter side is likely to be a Node B and the receiver side is likely to be a user equipment UE. It is unlikely that a UE will have the processing capability to carry out the processing required by the FIG. 2 receiver. Even if processing capability did become available, the power consumption associated with the processing would make the battery life of portable equipment undesirably short.

### SUMMARY OF THE INVENTION

In view of the problems described above, it is desirable to provide a communication method and system and a transmitter capable of selecting a suitable phase vector without an undue processing burden on the transmitter side. Alternatively, or in addition, it is desirable to provide a communication method and system and a receiver capable of identifying the phase vector selected by the transmitter without undue processing burden on the receiving side. Alternatively, or in addition, it is desirable to provide a communication method and system and a transmitter and a receiver in which a signalling overhead between the transmitter and the receiver is managed effectively and/or reduced.

According to a first aspect of the present invention there is provided a communication method in which a transmitter transmits a plurality of signals simultaneously to one or more receivers, each said signal carrying data, the method comprising: at the transmitter, selecting a suitable phase vector from among a plurality of available phase vectors to apply to the plurality of signals, each said available phase vector comprising a plurality of phase elements each of which corresponds to one or more of said signals and sets a phase adjustment to be applied by the transmitter to said corresponding signal(s); characterised in that the selection of the suitable phase vector is initially limited to phase vectors belonging to a first set of the available phase vectors within the plurality of available phase vectors, and is expanded to further phase vectors outside said first set when no suitable phase vector is found in said first set.

In such a method the processing burden at the transmitter that is associated with the selection of the phase vector is reduced. If a suitable phase vector is found in the first set, then it is not necessary to consider the further phase vectors outside the first set.

In the selection of the suitable phase vector, a suitability of such an available phase vector is based, in one embodiment of the present invention, on a peak-to-average power ratio (PAPR) reduction achievable by applying the phase vector concerned to the plurality of signals. This enables the invention to achieve useful PAPR reductions without an undue processing burden at the transmitter. In the case of PAPR reduction, the greater the number of available phase vectors that the transmitter has, the greater the likelihood of being able to achieve a good PAPR reduction for any given block of data to be transmitted. However, because the data to be transmitted is random, it will often be the case that a suitable phase vector for a particular block of data can be found in the first set of available phase vectors without having to consider further phase vectors outside the first set.

Preferably, the phase vectors of said first set are fewer in number than said further phase vectors outside said first set. This can lead to significant processing burden reductions whilst still achieving satisfactory results. For example, when the phase vectors are used for PAPR reduction, the first set may have ten times fewer phase vectors than there are further vectors, without significantly degrading PAPR performance.

A further advantage of this aspect of the invention arises if the transmitter transmits to the receiver identifying information identifying the selected phase vector, as is the case for example in the FIG. 1 system described above. In this case, an amount of said identifying information is smaller when the selected phase vector belongs to the first set than when the selected phase vector is one of said further phase vectors outside said first set. Thus, the amount of signalling associated with the transmission of the identifying information can be reduced. If there are 10 times fewer phase vectors in the first set than outside the first set, at least 3 fewer bits are required to transmit the identity of the phase vector when it comes from the first set.

The further vectors outside the first set may comprise one or more further sets of phase vectors. In a preferred embodiment, the plurality of available phase vectors are organised in a hierarchy of layers, said first set of phase vectors corresponding to a first one of said layers, and there being a second set of phase vectors corresponding to a second one of said layers, and so on for each higher layer, if any, of the hierarchy of layers. In this case the selection of the suitable phase vector may be expanded from one set to the next in accordance with said hierarchy of layers. In this way, as many phase vectors as are deemed necessary for adequate performance, e.g. PAPR performance, can be made available, but because the phase vectors are arranged in sets which are considered in turn the processing burden can still be kept manageable.

Preferably, the set corresponding to at least one said layer has fewer phase vectors than the set corresponding to a higher layer. This may be true for all layers, if desired.

In one embodiment, said first set has a threshold value for peak-to-average power ratio reduction, and it is judged that there is no suitable phase vector in said first set if none of the phase vectors in said first set is able to achieve a peak-to-average power ratio reduction above said threshold value for said first set. Thus, the further phase vectors are only considered if none of the first-set phase vectors can provide a good enough PAPR performance.

In a hierarchical system, such a threshold value is preferably provided for each set other than the set corresponding to the highest layer. For each set in turn other than the set corresponding to the highest layer it is judged that there is no suitable phase vector in that set if none of the phase vectors in that set is able to achieve a peak-to-average power ratio reduction above said threshold value for that set.

The threshold values for the different sets may be the same. However, on average the greater the number of vectors in a set, the more likely it is that a higher PAPR reduction will be achievable by one of the members of the set. Accordingly, if for example the sets contain increasing numbers of phase vectors, it may be appropriate to make the threshold value for the set corresponding to at least one layer lower than the threshold value for the set corresponding to a higher layer.

In one embodiment, for at least one set, all the phase vectors of the set are considered and the phase vector that is able to achieve the highest peak-to-average power ratio reduction is selected as the suitable phase vector provided that the reduction concerned is above said threshold value for the set. This will lead to the best available phase vector of the set being selected, so that the performance is improved.

However, the processing burden in such a case is fixed for the set. An alternative is possible in which, for at least one set, the phase vectors of the set are considered sequentially for suitability, and when a first suitable phase vector is found (e.g. one which achieves a PAPR reduction above the threshold value for the set) any remaining phase vectors of the set are not considered. This can lead to further processing burden savings, although at the expense of performance as the first suitable phase vector may not be the overall best available phase vector in the set. Of course, it would be possible to find the first N suitable phase vectors and select the best one of these N to improve the performance at the expense of some extra processing burden.

The transmitter may transmit to the receiver set information for use by the receiver to identify the set to which the selected phase vector belongs without transmitting any further information to identify the selected phase vector. This leads to greatly reduced signalling.

In this case, the receiver can operate on a semi-blind basis to recover the data from the received plurality of signals with knowledge only of the set to which the selected phase vector belongs.

Such a semi-blind receiver (see also the third aspect of the invention described below) may have a plurality of trial phase vectors corresponding respectively to the plurality of available phase vectors of the transmitter. Each trial phase vector may be identical to its corresponding available phase vector of the transmitter or may be derived from it. For example, each trial phase vector may be the complex conjugate of its corresponding available phase vector on the transmitter side.

The semi-blind receiver employs the set information to identify the set to which the selected phase vector belongs, and processes the received plurality of signals only with those trial phase vectors that correspond respectively to the available phase vectors of the identified set to recover the data from the received plurality of signals. This saves the receiver from having to use all of the trial phase vectors in a case in which, say, the selected phase vector belongs to the first set. Processing burden is therefore reduced on the receiver side in the same way as on the transmitter side.

It is also possible for the receiver to operate fully blindly, i.e. without the set information or any other information from the transmitter about the selected phase vector. This leads to even greater signalling requirement reductions. Like the semi-blind receiver, such a fully-blind receiver may have a plurality of trial phase vectors corresponding respectively to the plurality of available phase vectors of the transmitter. The fully-blind receiver may process all the trial phase vectors to recover the data, as in the FIG. 2 system described above. Preferably, however, the receiver (see also the fourth aspect of the invention described below) initially processes the received plurality of signals with those trial phase vectors that correspond respectively to the available phase vectors of the first set of available phase vectors to recover the data from the received plurality of signals, and expands the trial phase vectors to further trial phase vectors corresponding respectively to available phase vectors outside said first set when satisfactory data recovery is not achieved with any of the trial phase vectors that correspond respectively to the available phase vectors of the first set. This can lead to processing burden savings on the receiver side.

In another embodiment, at least one set is subdivided into a plurality of subsets, and the transmitter transmits to the receiver subset information for use by the receiver to identify the subset to which the selected phase vector belongs. The subset information requires fewer bits than information identifying the selected phase vector uniquely, so the signalling requirement can be reduced whilst giving the receiver some assistance in recovering the data and enabling it to reduce the associated processing burden.

Another version of the semi-blind receiver, suitable for use in this case, has a plurality of trial phase vectors corresponding respectively to the plurality of available phase vectors of the transmitter. The receiver employs the subset information to identify the subset to which the selected phase vector belongs, and processes the received plurality of signals only with those trial phase vectors that correspond respectively to the identified subset to recover the data from the received plurality of signals.

According to a second aspect of the present invention there is provided a transmitter adapted to transmit a plurality of signals simultaneously to one or more receivers, each said signal carrying data, the transmitter comprising: phase vector selecting means for selecting a suitable phase vector from among a plurality of available phase vectors to apply to the plurality of signals, each said available phase vector comprising a plurality of phase elements each of which corresponds to one or more of said signals and sets a phase adjustment to be applied by the transmitter to said corresponding signal(s); characterised in that the phase vector selecting means is operable initially to limit the selection of the suitable phase vector to phase vectors belonging to a first set of the available phase vectors within the plurality of phase vectors, and is further operable to expand the selection to further phase vectors outside said first set when no suitable phase vector is found in said first set.

According to a third aspect of the present invention there is provided a receiver adapted to receive a plurality of signals transmitted simultaneously by a transmitter which applied to the plurality of signals as transmitted a phase vector selected from among a plurality of available phase vectors, each said available phase vector comprising a plurality of phase elements each of which corresponds to one or more of said signals and sets a phase adjustment applied by the transmitter to said corresponding signal(s), and each said signal carrying data, said receiver comprising: processing means for processing the received plurality of signals with trial phase vectors of a plurality of trial phase vectors to recover said data from the received plurality of signals, said plurality of trial phase vectors corresponding respectively to the plurality of available phase vectors of the transmitter; characterised by: receiving means for receiving from the transmitter information for use in identifying a limited set of available phase vectors from among the plurality of available phase vectors, said selected phase vector belonging to said limited set; and limiting means for limiting said processing by the processing means to the trial phase vectors that correspond respectively to the available phase vectors of said limited set.

Here, the limited set may be any set of the first aspect of the invention in which the sets are considered one after the next to save transmitter-side processing burden. In this case the set may be communicated from the transmitter to the receiver using the set information mentioned above. The limited set could also be a subset of any of the sets of the first aspect of the invention. Alternatively, the limited set may simply be a subset of the entire plurality of available phase vectors rather than of some set such as the first set within that plurality.

According to a fourth aspect of the present invention there is provided a receiver adapted to receive a plurality of signals transmitted simultaneously by a transmitter which applied to the plurality of signals as transmitted a phase vector selected from among a plurality of available phase vectors, each said available phase vector comprising a plurality of phase elements each of which corresponds to one or more of said signals and sets a phase adjustment applied by the transmitter to said corresponding signal(s), and each said signal carrying data, said receiver comprising: processing means for processing the received plurality of signals with trial phase vectors of a plurality of trial phase vectors to recover said data from the received plurality of signals, said plurality of trial phase vectors corresponding respectively to the plurality of available phase vectors of the transmitter; characterised by: limiting means operable to limit the processing by said processing means initially to trial phase vectors of a first set of trial phase vectors within the plurality of trial phase vectors, and also operable to expand the processing to further phase vectors outside said first set if satisfactory data recovery is not achieved with any of the trial phase vectors of said first set.

In the receivers embodying the third and fourth aspects of the invention, the data recovery processing is not limited to detecting the minimum distance solution using the method of equation (5) or the simplified metric of equation (6). Any suitable data recovery process can be applied which can enable the receiver to recover the data blindly or semi-blindly, i.e. without being informed of the identity of the selected phase vector. Depending on the data recovery process, there may be certain restrictions on the available phase vectors at the transmitter, for example the available phase vectors may need to possess properties that prevent the receiver from confusing two or more available phase vectors in the data recovery process. Such restrictions may include prescribed minimum Hamming distances. In the case in which the receiver is informed of the identity of the selected phase vector using side information the data recovery process may be much simpler. For example, the receiver may simply apply the reverse phase adjustments to those applied in the transmitter.

According to a fifth aspect of the present invention there is provided a communication method in which a transmitter transmits a plurality of signals simultaneously to one or more receivers, each said signal carrying data, the method comprising: at the transmitter, selecting a suitable phase vector from among a plurality of available phase vectors to apply to the plurality of signals, each said available phase vector comprising a plurality of phase elements each of which corresponds to one or more of said signals and sets a phase adjustments to be applied by the transmitter to said corresponding signal(s); at the receiver, processing the received plurality of signals with trial phase vectors of a plurality of trial phase vectors to recover said data from the received plurality of signals, said plurality of trial phase vectors corresponding respectively to the plurality of available phase vectors of the transmitter; characterised in that: the transmitter transmits to the receiver information identifying a limited set of phase vectors within the plurality of available phase vectors, said selected phase vector belonging to said limited set; and the receiver identifies said limited set using the received information and limits the trial phase vectors which are processed to recover the data to those trial phase vectors that correspond respectively to the available phase vectors of said limited set.

Such a communication method can provide significant processing burden savings on the receiver side. It is not necessary in this aspect of the invention for the selection of the phase vector on the transmitter side to be carried out in the manner of the first aspect of the invention.

The plurality of available phase vectors may be arranged in two or more sets of available phase vectors and said information may identify the set to which the selected phase vector belongs. A first such set may have fewer available phase vectors than a second such set, as is preferable in the first aspect of the invention, or the sets may contain the same number of available phase vectors.

In one preferred embodiment, at least one said set is sub-divided into a plurality of subsets and said information identifies said set and said subset to which said selected phase vector belongs. The receiver identifies said set and said subset to which the slected phase vector belongs using the received information and limits the trial phase vectors that are processed to recover the data to those trial phase vectors that correspond respectively to the available phase vectors of the identified subset within the identified set.

The limited set may also simply be a subset of the entire plurality of available phase vectors rather than of some set such as the first set within that plurality. For example, the entire plurality of available phase vectors may be subdivided into sub-blocks, and the limited set may be one sub-block to which the selected phase vector belongs.

This aspect of the invention may also be used for PAPR reduction. In this case, in the selection of the suitable phase vector a suitability of such an available phase vector may be based on a peak-to-average power ratio reduction achievable by applying the phase vector concerned to the plurality of signals.

The transmitter may consider the phase vectors of the plurality of available phase vectors sequentially for suitability and when a first suitable phase vector is found any remaining available phase vectors are not considered. This can save transmitter-side processing burden, as noted above. It would also be possible to find the first N suitable phase vectors and select the best one of these N to improve the performance at the expense of some extra processing burden.

In another embodiment, all of the phase vectors of said plurality of available phase vectors are considered and the phase vector that is able to achieve the highest peak-to-average power ratio reduction is selected as the suitable phase vector. This achieves the best possible PAPR performance with the particular plurality of available phase vectors.

According to a sixth aspect of the present invention there is provided a transmitter adapted to transmit a plurality of signals simultaneously to one or more receivers, each said signal carrying data, the transmitter comprising: phase vector selecting means for selecting a suitable phase vector from among a plurality of available phase vectors to apply to the plurality of signals, each said available phase vector comprising a plurality of phase elements each of which corresponds to one or more of said signals and sets a phase adjustment to be applied by the transmitter to said corresponding signal(s); characterised by transmitting means operable to transmit to the receiver information identifying a limited set of phase vectors within the plurality of available phase vectors, said selected phase vector belonging to said limited set.

According to a seventh aspect of the present invention there is provided a communication method in which a transmitter transmits a plurality of signals simultaneously to one or more receivers at a series of times, each said signal carrying data, the method comprising: at the transmitter, selecting a suitable phase vector from among a plurality of available phase vectors to apply to the plurality of signals transmitted at each of said times, each said available phase vector comprising a plurality of phase elements each of which corresponds to one or more of said signals and sets a phase adjustment to be applied by the transmitter to the corresponding signal(s) transmitted at said time concerned; and transmitting from the transmitter to the receiver identifying information for use by the receiver to identify the phase vector selected by the transmitter for the transmission of the plurality of signals at each said time; characterised in that said identifying information for the transmission at one of said times differs from the identifying information for the transmission at another one of said times in at least one of an amount of said information, a format of said information, and a granularity of said information.

Such a communication method can enable a signalling requirement arising from the transmission of the identifying information to be managed effectively and in some cases reduced. In particular, there is a trade-off between receiver-side processing burden and signalling overhead. By using different formats, amounts of information and/or granularities for the identifying information of different transmissions, a satisfactory trade-off result can be obtained. The satisfactory trade-off result may depend, for example, on the processing capabilities of the receiver, and other factors which vary from one system to another. For example, if the receiver is in a Node-B processing capability is high, so reduction of the signalling requirement may be possible. On the other hand, if the receiver is in a UE, processing capability may be low, so reduction of the processing burden on the receiver may be more important than saving signalling.

The plurality of available phase vectors may, for example, comprise at least first and second sets of available phase vectors. In this case, said identifying information for the transmission at each said time when said selected phase vector belongs to said first set may have a first amount of information and said identifying information for the transmission at each said time when said selected phase vector belongs to said second set may have a second amount of information different from said first amount. Alternatively, or in addition, said identifying information for the transmission at each said time when said selected phase vector belongs to said first set may have a first format and said identifying information for the transmission at each said time when said selected phase vector belongs to said second set may have a second format different from said first format. Alternatively, or in addition, said identifying information for the transmission at each said time when said selected phase vector belongs to said first set may have a first granularity and said identifying information for the transmission at each said time when said selected phase vector belongs to said second set may have a second granularity different from said first granularity.

The first set may have fewer phase vectors than said second set, in which case said first amount of information can be smaller than said second amount of information. This can reduce the signalling overhead.

The identifying information may identify the suitable phase vector uniquely (i.e. with full granularity) when the selected phase vector belongs to said first set and when the selected phase vector belongs to said second set. This reduces the receiver-side processing burden vastly, as no blind or semi-blind operation is required.

Alternatively, the identifying information may merely identify the set when said selected phase vector belongs to one of said sets. This saves signalling overhead at times when that one set is involved but the receiver will have to operate semi-blindly at those times, increasing its processing burden.

When the first set has fewer phase vectors than said second set, the identifying information may merely identify the set when said selected phase vector belongs to said first set. This saves signalling when the first set is selected, and even with a low processing capability the receiver may be capable of working blindly within the first set. However, because the second set is larger, blind operation may not be practical in this case, so the identifying information for the second set may include at least something to narrow down the number of vectors to be tried for the second set.

When the first set has fewer phase vectors than said second set, another possibility is for the identifying information to identify said selected phase vector with a first granularity when the selected phase vector belongs to said first set and with a second granularity, lower than said first granularity, when said selected phase vector belongs to said second set. For example, the first granularity may be full granularity, i.e. identifying the selected phase vector uniquely, and the second granularity may be some lesser specificity, for example only identifying one sub-block.

In one embodiment, said identifying information has the same amount of information when the selected phase vector belongs to said first set and when said selected phase vector belongs to said second set. This may be desirable in some systems where certain dedicated time slots or bits are reserved for the signalling of the identifying information.

At least one set may be sub-divided into a plurality of subsets and when the selected phase vector belongs to that set said identifying information identifies the subset to which the selected phase vector belongs.

In the selection of the suitable phase vector a suitability of such an available phase vector may be based on a peak-to-average power ratio reduction achievable by applying the phase vector concerned to the plurality of signals.

According to a tenth aspect of the present invention there is provided a transmitter adapted to transmit a plurality of signals simultaneously to one or more receivers at a series of times, each said signal carrying data, which transmitter comprises: phase vector selecting means for selecting a suitable phase vector from among a plurality of available phase vectors to apply to the plurality of signals transmitted at each of said times, each said available phase vector comprising a plurality of phase elements each of which corresponds to one or more of said signals and sets a phase adjustment to be applied by the transmitter to the corresponding signal(s) transmitted at said time concerned; and transmitting means for transmitting from the transmitter to the receiver identifying information for use by the receiver to identify the phase vector selected by the transmitter for the transmission of the plurality of signals at each said time;characterised in that said identifying information for the transmission at one of said times differs from the identifying information for the transmission at another one of said times in at least one of an amount of said information, a format of said information, and a granularity of said information.

According to an eleventh aspect of the present invention there is provided a receiver adapted to receive a plurality of signals transmitted simultaneously by a transmitter at a series of times, each said signal carrying data, and the transmitter having applied to the plurality of signals as transmitted a phase vector selected from among a plurality of available phase vectors, each said available phase vector comprising a plurality of phase elements each of which corresponds to one or more of said signals and sets a phase adjustment applied by the transmitter to said corresponding signal(s) transmitted at said time concerned, said receiver comprising: information receiving means for receiving from the transmitter identifying information for use by the receiver to identify the phase vector selected by the transmitter for the transmission of the plurality of signals at each said time; characterised in that the received identifying information for the transmission at one of said times differs from the received identifying information for the transmission at another one of said times in at least one of an amount of said information, a format of said information, and a granularity of said information; and the receiver further comprises identifying information processing means operable to process said identifying information for the transmission at each said time according to its particular said amount, format or granularity of information, as the case may be; and data recovery means operable to employ the processed identifying information to recover said data from the received plurality of signals.

It will be appreciated by those skilled in the art that the present invention may be implemented in hardware or software or in a combination of the two. For example, each transmitter and each receiver mentioned above may have a processor such as a digital signal processor (DSP), or a computer, which operates according to a program. According to other aspects of the present invention there are provided programs adapted to be executed on the processor or computer in such a transmitter or receiver to cause it to carry out its functions. Such a program may be provided by itself or on a carrier medium. The carrier medium may be a recording medium such as a CD-ROM or a transmission medium such as a signal.

Each transmitter as described above may be included in a Node-B (base station) of a wireless communication system or in a UE (user terminal or mobile station) of such a system. Thus, according to a further aspect of the present invention there is provided a base station of a wireless communication system, said base station comprising a transmitter embodying any of the aforementioned second, sixth and tenth aspects of the present invention. According to a further aspect of the present invention there is provided a user terminal of a wireless communication system, said user terminal comprising a transmitter embodying any of the aforementioned second, sixth and tenth aspects of the present invention. According to a further aspect of the present invention there is provided a base station comprising a receiver embodying any of the aforementioned third, fourth and eleventh aspects of the present invention. According to a further aspect of the present invention there is provided a user terminal comprising a receiver embodying any of the aforementioned third, fourth and eleventh aspects of the present invention.

The communication system may be an OFDM system.

The data carried by the signals may be user data, or control information such as pilot information, or a combination of the two.

### BRIEF DESCRIPTION OF THE DRAWINGS

FIG. 1, discussed hereinbefore, shows parts of an OFDM communication system employing SLM;

FIG. 2, also discussed hereinbefore, shows parts of a blind receiver adapted for use in an SLM method;

FIG. 3 shows parts of a communication system according to a first embodiment of the present invention;

FIG. 4 is a flowchart for use in explaining operations carried out in a transmitter of the FIG. 3 system;

FIG. 5 is a schematic view for use in explaining signalling in the FIG. 3 system;

FIG. 6 is a graph illustrating a variation of a bit error rate with signal-to-noise ratio of the FIG. 3 system when the number of subcarriers is 128;

FIG. 7 is a graph corresponding to FIG. 6 but for 256 subcarriers;

FIG. 8 shows parts of a communication system according to a second embodiment of the present invention;

FIG. 9 is a schematic view for use in explaining signalling in the FIG. 8 system;

FIG. 10 shows parts of a communication system according to a third embodiment of the present invention;

FIG. 11 is a graph illustrating a variation of a bit error rate with signal-to-noise ratio of the FIG. 10 system when a modulation scheme is 16 QAM;

FIG. 12 is a graph illustrating a variation of a bit error rate with signal-to-noise ratio of the FIG. 10 system when a modulation scheme is QPSK;

FIGS. 13(A) to 13(D) are schematic views for illustrating various signalling possibilities in embodiments of the present invention.

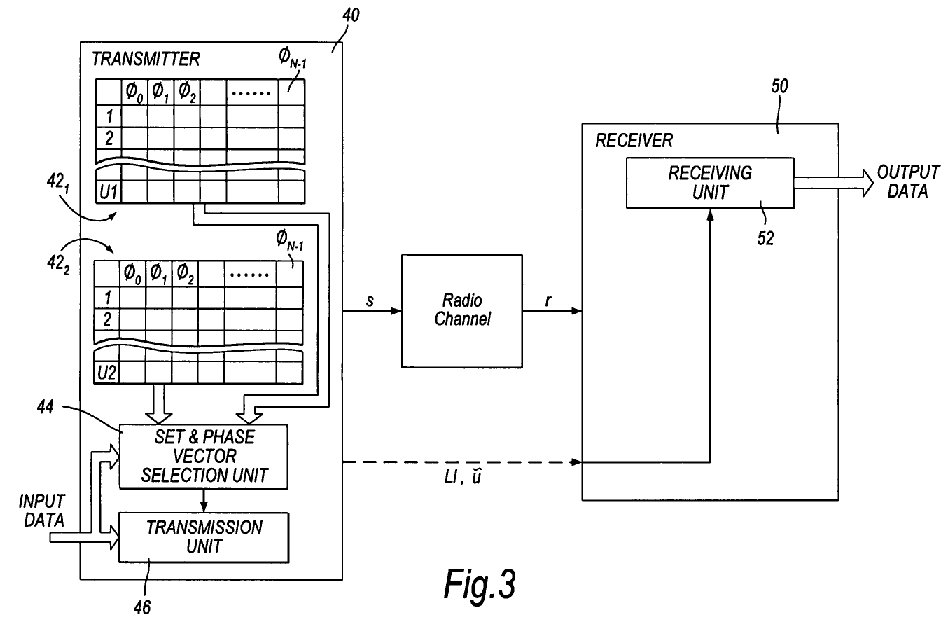

FIG. 3 shows parts of a communication system according to a first embodiment of the present invention. The FIG. 3 system is an OFDM system having N subcarriers, but the present invention is applicable to communication systems other than OFDM systems.

### DETAILED DESCRIPTION OF THE PREFERRED EMBODIMENTS

The FIG. 3 system comprises a transmitter 40 and a receiver 50. In this embodiment, it is assumed that the transmitter and receiver are adapted for wireless communication, but embodiments of the present invention are also applicable to communication systems having a wire connection between the transmitter and the receiver. The transmitter 40 is, for example, a Node B of a wireless communication system, and the receiver 50 is, for example, a user equipment (UE) of such a wireless communication system.

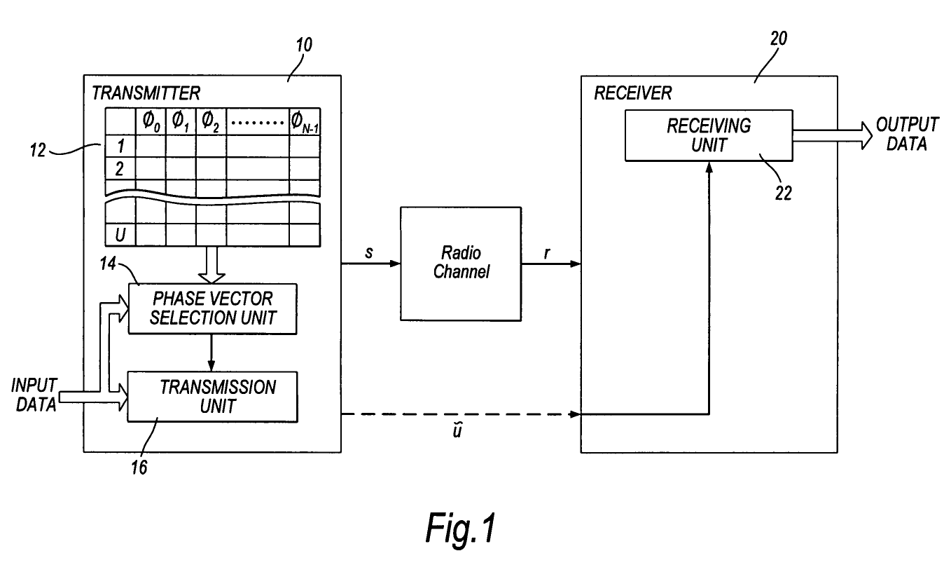

The transmitter 40 differs from the transmitter described previously with reference to FIG. 1 in that it has two sets of available phase vectors from which it can select a phase vector to apply to a given block of input data. Although for the sake of simplicity only two such sets are used in this embodiment, as described later more than two sets of available phase vectors could be provided.

The first set of available phase vectors comprises U1 phase vectors in total, and the second set of available phase vectors comprises U2 phase vectors in total, where U2>U1. For example, U2=10×U1. The phase vectors in the first and second sets are mutually exclusive.

Each phase vector is made up of N phase elements. In this embodiment, each phase element corresponds to a different one of the N subcarriers and sets a phase adjustment to be applied by the transmitter 40 to the corresponding subcarrier.

As shown in FIG. 3 the transmitter 40 comprises a first phase vector storage unit 42₁ for storing data relating to the first set of phase vectors, and a second phase vector storage unit 42₂ for storing data relating to the phase vectors of the second set of phase vectors.

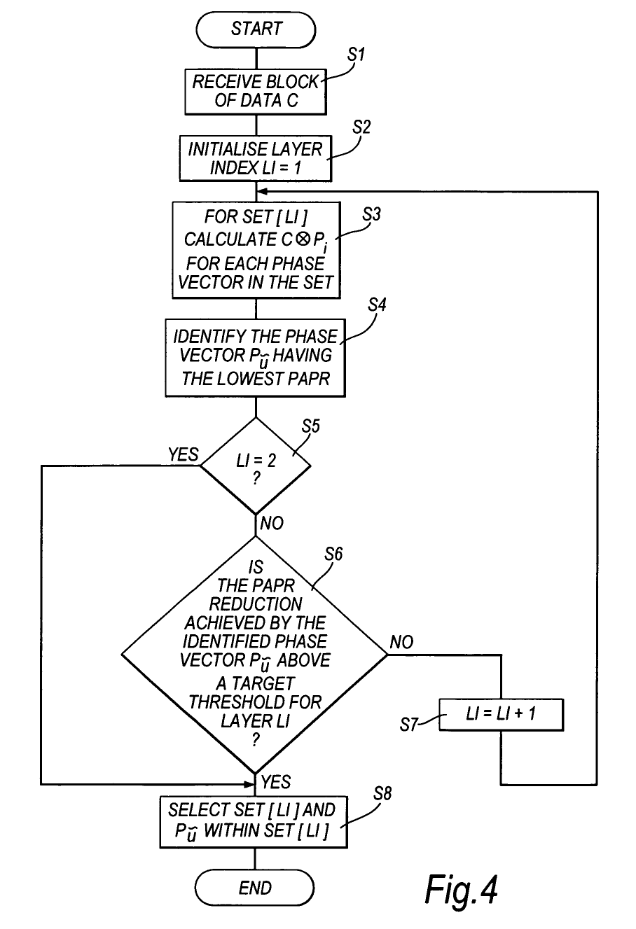

The transmitter 40 also comprises a set and phase vector selection unit 44 which is connected to both of the phase vector storage units 42₁ and 42₂. The set end phase vector selection unit 44 is also connected to receive blocks of input data. Each block constitutes an OFDM symbol to be transmitted in one transmission time interval (TTI). The set and phase vector selection unit 44 selects a set and a phase vector within the selected set to apply to each block of data, as will now be described with reference to FIG. 4.

In FIG. 4, in step S1 the set and phase vector selection unit 44 receives a block C of data to be transmitted to the receiver 50. In step S2, a layer index LI is initialised to the value 1. In this embodiment, the first set of phase vectors is considered to belong to layer 1 and the second set of phase vectors is considered to belong to layer 2. In step S3, the set and phase vector selection unit 44 calculates the vector product C⊕Pᵢ for each one of the available phase vectors of the set of phase vectors for the current layer (layer 1).

In step S4 the phase vector P_{ũ} having the lowest PAPR is identified, for example by applying equation (3) above to each vector product, and looking for the minimum PAPR value. In step S5 it is checked whether the final layer (layer 2 in this case) has been reached. If not, as is the case here, processing moves to step S6. In step S6 a check is made whether the PAPR reduction achieved by the phase vector P_{ũ} identified in step S4 is above a target threshold for the current layer (layer 1). The target threshold is dependent on the modulation scheme, the number of sub-carriers and the characteristics of the amplifier.

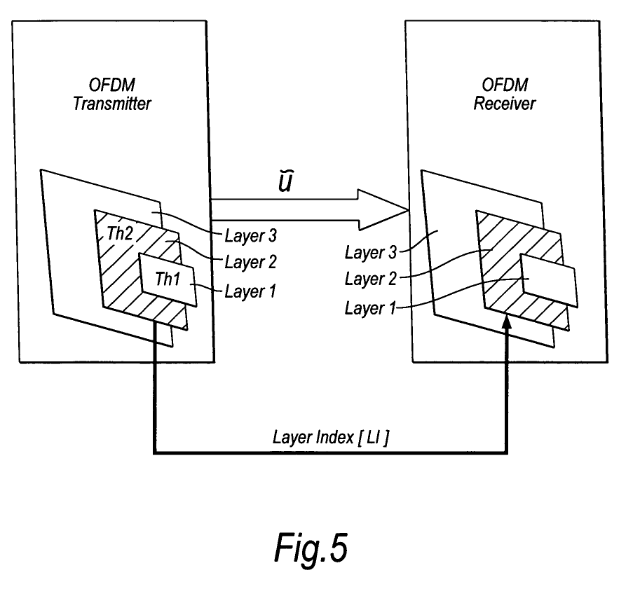

In this embodiment, there are only two layers, and a threshold is only set for layer 1. However, in other embodiments, more than two layers may be used as a hierarchy of layers. In this case, the threshold for layer 2 may be set higher than the threshold for layer 1. The reason is that the greater the number of available phase vectors in the set associated with the layer, the higher the expected PAPR reduction on average. FIG. 5 shows an example having three layers, with thresholds Th1 and Th2 for layers 1 and 2 respectively.

Incidentally, although FIG. 5 shows the same three layers in the receiver, in the first embodiment the transmitter sends the identity of the selected phase vector to the receiver, so it is not necessary to organise the phase vectors in the receiver into different sets corresponding to the layers.

Example values of the target threshold for layer 1 are 5.9 dB in the case in which the number of subcarriers is 128, and 6.6 dB in the case in which the number of subcarriers is 256.

If phase vector P_{ũ} achieves a PAPR reduction above the target threshold for the current layer in step S6, processing proceeds to step S8 in which the set of the current layer (first set) is selected and the phase vector P_{ũ} having the lowest PAPR within the set is also selected. Processing then terminates, and the block C of data is transmitted by the transmission unit 46 to the receiver using the selected phase vector P_{ũ}.

If, on the other hand, in step S6 it is found that even the phase vector Pᵤ having the lowest PAPR fails to provide a PAPR reduction above the target threshold for the current layer, then processing proceeds to step S7 in which the layer index LI is incremented to switch to the next layer (layer 2 in the present case). The processing of steps S3 and S4 is then repeated for the second set of available phase vectors. When processing reaches step S5 it is found that the current layer is layer 2 and processing proceeds to step S8. Accordingly, the set of layer (second set) 2 is selected and the phase vector P_{ũ} having the lowest PAPR within the second set is also selected. Processing then terminates and the transmission unit 46 transmits the block C using the selected phase vector from the second set.

It will be understood that in the first embodiment the selection of a suitable phase vector is initially limited to phase vectors belonging to the first set. The selection is expanded to further phase vectors outside the first set, i.e. the second set, when no suitable phase vector is found in the first set. As a result, the selected phase vector will come from the first set at some times (TTIs) and from the second set at other times (TTIs). The set from which the selected phase vector comes depends in this case on the data of the block to be transmitted in each TTI and on the PAPR reductions that are achievable for that data by the particular phase vectors of the sets. The reduction in the processing burden associated with the selection of the phase vector in the transmitter 40 depends on the ratio between the number of times that a suitable phase vector is available in the first set compared to the number of times that a suitable phase vector is available only in the second set.

The reduction in the processing burden of the selection of the phase vector can be defined as

$$λ = \frac{{\sum }_{i = 1}^{L} {U}_{TOTAL} ( {L}_{i} )}{{U}_{TOTAL} ( SLM )} \qquad ( 7 )$$

where U_{TOTAL} (Lᵢ) represents the total number of vectors processed in steps S3 and S4 over a series of data blocks, and U_{TOTAL} (SLM) represents the total number of vectors which would be processed in the previously-considered transmitter 10 of FIG. 1. Over a simulated series of 10,000 data blocks, it was found that for U1=160, U2=1600, λ=0.45, i.e. there is a 55% reduction in the processing burden compared to the transmitter of FIG. 1 having U=1600.

In the first embodiment, the transmitter 40 transmits the layer index LI and the identity ũ of the selected phase vector to the receiver 50 as side information. FIG. 5 is a schematic view showing the way in which the side information is transmitted from the transmitter to the receiver in the FIG. 3 system. This side information is used by the receiving unit 52 in the receiver to recover the data from the received signal. The receiver 50 knows the available phase vectors of both the first and second sets. For example, although not shown in FIG. 3, the receiver 50 may comprise first and second phase vector storage units identical to the storage units 42, and 42₂ provided in the transmitter. Alternatively, the receiver-side storage units may store data relating to the conjugates of the phase vectors. Given the side information, the receiving unit 52 can obtain the term e^{jφ}^{ₙ}^{ũ} and use it to determine cₙ for example based on equation (4) above.

Because the number U1 of phase vectors in the first set is smaller than the number U2 of phase vectors in the second set, in the case in which the selected phase vector comes from the first set, the number of bits required to transmit the identity ũ of the selected phase vector can be smaller. For example, in the case mentioned above in which U1=160, 8 bits are sufficient to convey ũ, compared to the 11 bits required to convey ũ for the second set. Thus, as well as achieving a reduction in the transmitter processing burden, the first embodiment can also achieve a reduction in the signalling overhead.

The performance of the FIG. 3 system was simulated using the simulation assumptions set out in Table 1 below.

TABLE 1

| Parameter | Value |
|---|---|
| Total number of subcarriers | 128, 256 |
| Synchronisation | Perfect |
| Modulation | 16 QAM |
| Sampling rate | 256 and 512 samples per symbol |
| Clipping Level | 2 dB |
| Subcarrier spacing | 19.5 KHZ |
| Channel | AWGN |
| Number of layers | 2 |
| Number of required signalling | 1 |
| bits | |
| Threshold for 128 carriers | 5.9 dB |
| Threshold for 256 carriers | 6.6 dB |
| U2 (larger layer) | 1600 |
| U1 (Smaller layer) | 160 |
| U (Traditional SLM) | 1600 |

Two versions of the system were simulated, the first version having 128 subcarriers and the second version having 256 carriers. In both cases, there were just two layers. The target threshold for layer 1 for the first version was 5.9 dB and for the second version was 6.6 dB.

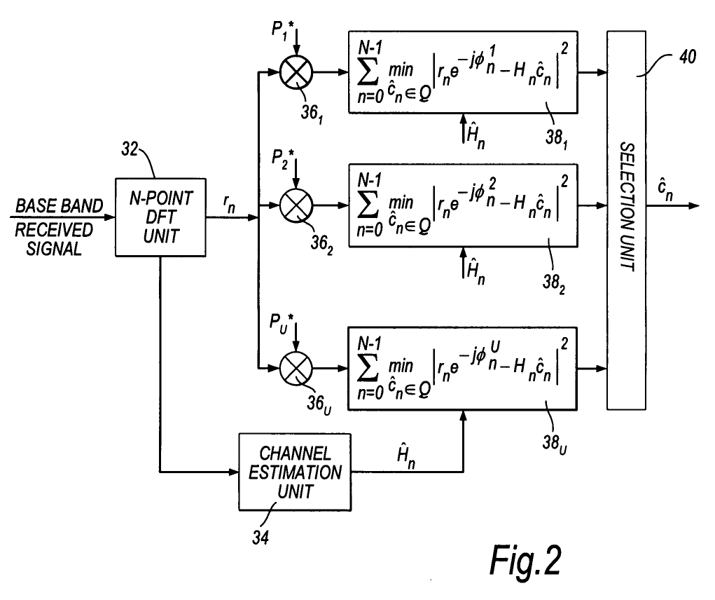

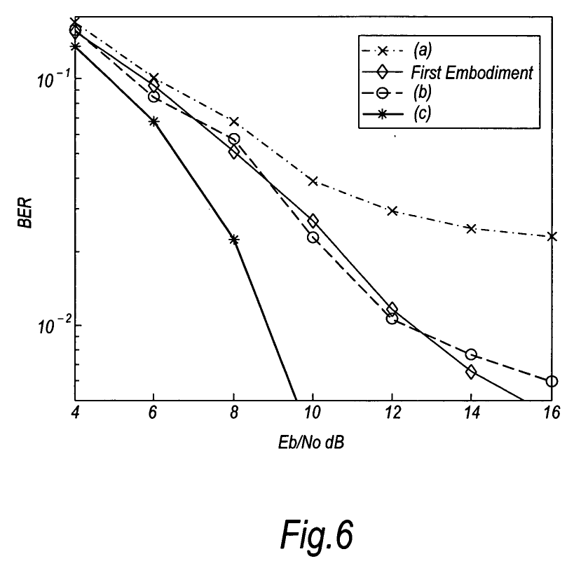

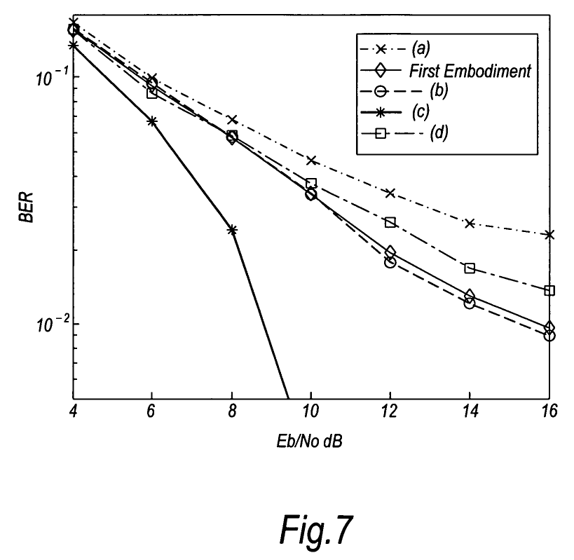

The results of the simulation for the first version are shown in FIG. 6 and the results of the simulation for the second version are shown in FIG. 7. In both cases, the variation of a bit error rate (BER) with signal to noise ratio (Eb/No) was plotted. The performance of a communication system according to the first embodiment was compared with (a) a system having no PAPR reduction, (b) the previously-considered system of FIG. 1 using U=U2 phase vectors, and (c) an ideal system. In the case of FIG. 7, an additional system is considered, which is the system of FIG. 1 with U=U1 phase vectors. From FIGS. 6 and 7 it can be observed that the system of FIG. 3 performs almost as well as the system (b) of FIG. 1 having U2 phase vectors, despite achieving a processing burden reduction on the transmitter side of 55%. From FIG. 7 it can be observed that the system of FIG. 3 performs much better than the system (d) of FIG. 2 having U1 phase vectors.

The PAPR performance of the first embodiment was compared with that of (a) the system of FIG. 1 (in which the transmitter transmits the identity ũ of the selected phase vector to the receiver) and (b) a system not having PAPR reduction. In the case of system (a) the number of available phase vectors was assumed to be 1600. In the case of the second embodiment, U1 was assumed to be 160 and U2 was assumed to be 1600. Again, two versions of the systems were considered, the first having 128 subcarriers and the second having 256 subcarriers. The results are presented in Table 2 below. The values in Table 2 represent the PAPR level before the soft-limiting non-linear amplifier. The values were measured and averaged over 10,000 independent transmission periods.

TABLE 2

| PAPR Reduction | PAPR (dB) | PAPR (dB) |
|---|---|---|
| Techniques | Level (128 Subcarriers) | Level (256 Subcarriers) |
| Traditional SLM | 5.8055 | 6.51 |
| Proposed | 5.8490 | 6.585 |
| No PAPR | 9.1578 | 9.156 |
| Reduction | | |

As can be seen from Table 2 the first embodiment achieves almost the same degree of PAPR reduction as the system of FIG. 1 whilst achieving a significant reduction in transmitter processing burden.

Incidentally, the true impact of PAPR reduction can be observed more clearly when the simulation is carried out for more transmission periods (i.e. closer to a practical situation). In that case, all of the systems other than the ideal system will tend to have higher bit error rates simply because a more extreme PAPR level is likely to be experienced at some time. However, it is still expected that the performance of the FIG. 3 system will be close to the performance of the FIG. 1 system having U2 phase vectors.

Next, a variation of the first embodiment will be described.

Referring back to FIG. 4, it can be seen that in steps S3 and S4 the set and phase vector selection unit 44 considers all the phase vectors in the set applicable to the current layer LI and identifies the phase vector within that set which has the lowest PAPR. This is desirable because it enables the best-available PAPR reduction to be achieved for the set concerned. However, it is not essential for the set and phase vector selection unit 44 to consider all of the phase vectors in the current set. For example, the phase vectors may be considered sequentially. As each of the phase vectors is considered in turn, its PAPR reduction is calculated and compared with a threshold value (which may be the same as the threshold value in step S5). When the first phase vector which achieves a PAPR reduction above the threshold is found, it is unnecessary to go on to consider the remaining phase vectors in the set. As a result, the overall PAPR performance of the system will be reduced but the processing burden on the transmitter is reduced still further.

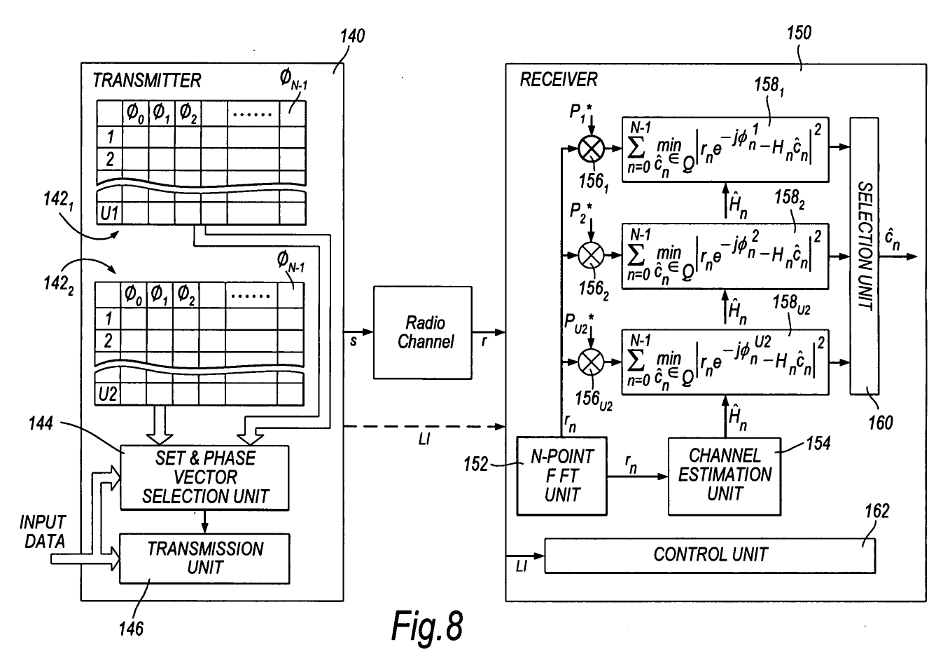

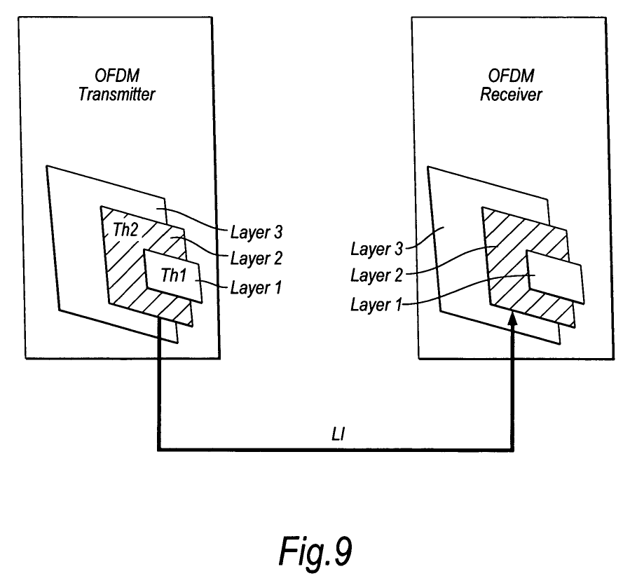

Next, a second embodiment of the present invention will be described with reference to FIGS. 8 and 9.

The communication system of the second embodiment is shown in FIG. 8 and comprises a transmitter 140 and a receiver 150. The transmitter 140 is generally similar to the transmitter 40 of the first embodiment. In particular, the transmitter 140 comprises first and second phase vector storage units 142₁ and 142₂ which are the same as the first and second phase vector storage units 42₁ and 42₂ described previously with reference to FIG. 3. The transmitter 140 also comprises a set and phase vector selection unit 144 which is the same as the set and phase vector selection unit 44 described previously with reference to FIG. 3.

The transmitter 140 also comprises a transmission unit 146 which is similar to the transmission unit 46 described with reference to FIG. 3. However, whereas the transmission unit 46 in FIG. 3 transmits both the layer index LI and the identity ũ of the selected phase vector for that layer, the transmission unit 146 in FIG. 8 transmits only the layer index LI, as shown in FIG. 9. The identify ũ of the phase vector within the selected layer is not transmitted by the transmission unit 146.

Because the transmission unit 146 does not transmit the identity ũ of the selected phase vector, the receiver 150 has a different constitution to that of the receiver 50 in FIG. 3. The receiver 150 is “semi-blind”, in the sense that the only information it receives from the transmitter for use in identifying the selected phase vector is the layer index LI. However, as in the case of the receiver 50 the receiver 150 knows all the phase vectors in both sets of phase vectors used by the transmitter 140. The receiver has storage units (not shown) which store data relating to a set of trial phase vectors for each layer. Each trial phase vector corresponds individually to one of the available phase vectors at the transmitter. In this embodiment, each trial phase vector is simply the same phase vector as its corresponding available phase vector. The storage units in the receiver are therefore the same as the storage units 142₁ and 142₂ of the transmitter but, alternatively, the storage units in the receiver may store data relating to the complex conjugates Pᵢ* of the phase vectors, since this is what is required for application to the complex multipliers 156ᵢ.

The receiver 150 comprises an N-point FFT unit 152 which receives the baseband signal. In this embodiment the FFT unit 152 subjects the baseband signal to FFT demodulation processing but in other embodiments discrete Fourier transform (DFT) processing may be used. The FFT unit 152 outputs rₙ.

The receiver also comprises a channel estimation unit 154 which is connected to the FFT unit 152 for receiving rₙ. The channel estimation unit 154 produces a channel estimate Ĥₙ for the channel associated with each sub-carrier.

The receiver 150 also comprises U2 vector multipliers 156₁ to 156_{U2} and U processing units 158₁ to 158_{U2}. As can be seen from the transmitter 140 in FIG. 8, U2 is the number of phase vectors in the second (larger) set of available phase vectors.

The received signal rₙ after the FFT demodulation in the FFT unit 152 is applied to a first input of each of the vector multipliers 156ᵢ. Each vector multiplier 156ᵢ also has a second input to which the complex conjugate Pᵢ* of one of the trial phase vectors Pᵢ is applied. Each vector multiplier 156ᵢ outputs the vector product r⊕Pᵢ* to its corresponding processing unit 158ᵢ.

Although not shown in FIG. 8, each processing unit 158ᵢ comprises a hard decision unit which, for each subcarrier, detects rₙ into the nearest constellation point ĉₙ. This hard decision is made by comparing rₙ with Hₙcₙe^{jφ}^{ₙ}^{ũ}

Each processing unit 158ᵢ is associated with a different one of the trial phase vectors Pᵢ but must consider each of the available constellation points for the modulation scheme applied to the subcarriers. For example, in the case of QPSK, there are four available constellation points. This means that for QPSK each processing unit 158ᵢ considers each of the four available constellation points and determines which one of the available constellation points provides the minimum distance H⊕ĉ to r⊕Pᵢ* for its associated phase vector Pᵢ. This can be done using the Viterbi algorithm. Results from the processing units are then compared by a selection unit 160 which selects the minimum Euclidian distance solution. This selection yields the data sequence ĉₙ. The identity ũ of the particular phase vector which provided the minimum distance solution is not explicitly output, but of course could be output if required by some other part of the receiver. It will be understood that the vector multipliers 156, processing units 158 and selection unit 160 together implement the decision metric of equation (6) above.

The receiver 150 also comprises a control unit 162 which controls the overall operation of the receiver.

When the layer index LI is received from the transmitter 140 the control unit 162 retrieves data from the relevant receiver-side storage unit (not shown) for the layer indicated by the layer index LI. In the case in which the layer index indicates the first layer, only the U1 trial phase vectors from the first set need to be processed. Accordingly, the complex conjugates of those U1 trial phase vectors are applied to the first U1 vector multipliers 156₁ to 156_{U1}, and only the processing units 158₁ to 158_{U1} are employed. The complex multipliers 156_{U1+1} to 156_{U2} and the corresponding processing units 158_{U1+1}, to 158_{U2} are deactivated, so as to save battery power.

In the case in which the received layer index LI indicates the second layer (layer 2), all the complex multipliers 156₁ to 156_{U2} and all the processing units 158₁ to 158_{U2} are used.

The processing requirement for the receiver 150 in the second embodiment is of course much higher than the processing requirement of the transmitter 50 in the first embodiment, because the transmitter is operating on a semi-blind basis. However, because the receiver is supplied with the layer index LI as side information, at least in the case in which the layer index indicates the first layer, the processing burden on the receiver is reduced as compared to the fully blind receiver described previously with reference to FIG. 2. The actual reduction in processing burden depends on the ratio of the number of times that the first layer is selected compared to the number of times that the second layer is selected. As explained above in relation to the processing burden reduction on the transmitter side in the first embodiment, it is expected that the processing burden on the receiver may also be reduced significantly compared to the fully blind receiver.

The main benefit of the second embodiment, as compared to the first embodiment, is in the reduction of the signalling overhead. In the case in which there are only two available layers, the layer index LI will require only a single bit, for example a “0” for layer 1 and a “1” for layer 2.

Table 3 below presents a comparison between the first and second embodiments of the invention described above; (a) a communication system using SLM as shown in FIG. 1 (i.e. transmitting the identity ũ of the selected phase vector from the transmitter to the receiver); and (b) a system having a blind receiver as described with reference to FIG. 2. The systems are compared in three respects, namely transmitter processing burden, receiver processing burden and signalling requirements.

TABLE 3

| | Transmitter | Receiver | |
|---|---|---|---|
| | Processing | Processing | Signalling |
| System | Burden | Burden | Required |
| FIG. 1 system | High | Low | Prohibitive |
| FIG. 2 system | High | Prohibitive | None |
| First embodiment | Low | Low | Medium |
| Second embodiment | Low | Medium | Low |

Next, a variation on the second embodiment will be described. In this variation, the transmission unit does not send any information about the selected layer to the receiver either, and the receiver operates completely blindly. In this case, the receiver may either process the layers sequentially, starting with the first layer, or may process all of the layers simultaneously. To process the layers sequentially, the number of vector multipliers 156 and processing units 158 need only be equal to the number U2 of phase vectors in the set for the highest layer. If the receiver is to process trial phase vectors of all layers simultaneously, then U1+U2 vector multipliers 156 and processing units 158 are required.

This variation on the second embodiment has the advantage that it removes entirely the signalling overhead associated with transmitting from the transmitter to the receiver any information about the phase vector selected by the transmitter. However, there is a significant penalty at the receiver in terms of processing burden as the receiver is not guided to the correct set of phase vectors by the layer information. If the receiver is a Node B (base station) it is likely to have the processing power to go blindly through all the layers to discover the phase vector without any need for the UE to send even the layer index. The processing power available in the UE is likely to be small compared to that available in the node B, so the arrangement of FIG. 8 is probably better for the case in which the transmitter is the node B and the receiver is the UE.

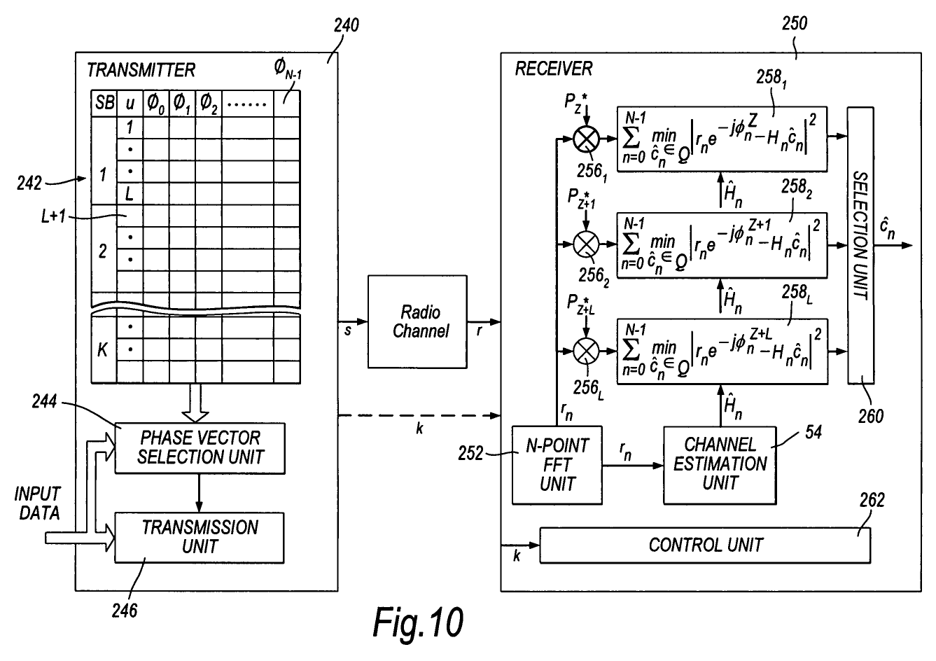

Next, a third embodiment of the present invention will be described with reference to FIG. 10. In FIG. 10 a communication system comprises a transmitter 240 and a receiver 250. The transmitter 240 in this embodiment has a single phase vector storage unit 242 in place of the two storage units in the preceding embodiments. The phase vector storage unit 242 has capacity for storing U=K×L phase vectors. For example U may be 256, K may be 8 and L may be 32. In this way, as represented in FIG. 10, the available phase vectors may be considered to be divided into K sub-blocks SB1 to SBK, each sub-block being made up of L phase vectors.

The transmitter 240 further comprises a phase vector selection unit 244 which selects that one of the U available phase vectors stored in the phase vector storage unit 242 that will provide the lowest PAPR for the current block of input data received by the transmitter 240.

The transmitter 240 also comprises a transmission unit 246 which transmits an OFDM signal formed by applying the selected phase vector to the block of data to be transmitted.

The transmitter has the same general constitution as the receiver 150 in FIG. 8 and is also a semi-blind receiver. However, the receiver 250 differs from the receiver of FIG. 8 in that only L vector multipliers 256₁ to 256_{L} and L processing units 258₁ to 258_{L} are provided in place of the U2 vector multipliers 156 and processing units 258 in FIG. 8. Thus, the number of vector multipliers and processing units is reduced by the factor K.

The receiver 250 also differs from the receiver 150 of FIG. 8 in that it has a control unit 262 which is adapted to receive the index k of the sub-block containing the phase vector selected by the phase vector selection unit 244.

The receiver 250 further comprises a storage unit (not shown) which stores data relating to U trial phase vectors corresponding respectively to the U available phase vectors on the transmitter side. The storage unit in the receiver in this embodiment contains the same data as the phase vector storage 242 in the transmitter 240 but, alternatively, it could store data relating to the U total phase vectors in some other suitable form, for example the complex conjugate of each of the available phase vectors, as this is what is required by the vector multipliers 256₁ to 256_{L}. The U trial phase vectors are also subdivided into K sub-blocks in the same way as the U available phase vectors.

Based on the received sub-block index k, the control unit 262 determines the sub-block of trial phase vectors used to recover the data from the received signal rₙ. In particular, the control unit 262 calculates Z=(k−1) L+1. Then, the control unit 262 retrieves from the receiver-side storage unit the data for the trial phase vectors P_{Z} to P_{Z+L} of the sub-block SBK. In this way, the complex conjugates P_{Z}* to P_{Z+L}* of the L trial phase vectors P_{Z} to P_{Z+L} of the sub-block SBk are applied respectively to the inputs of the vector multipliers 256₁ to 256_{L}. The processing units 258₁ to 258_{L} then determine the minimum distance H⊕ĉ to r⊕P* for each of the trial phase vectors P_{Z} to P_{Z+L} for all the possible constellation points of the modulation scheme being applied to the subcarriers. A selection unit 260 then selects the minimum-distance solution among the phase vectors P_{Z} to P_{Z+L} and this yields the output data ĉₙ.

The decision metric used in the receiver 250 in this embodiment is represented by

$${D}_{Semi\_Blind} = {min}_{{P}_{\hat{u}} , \hat{u} ∈ \{ 1 , 2 , … , L \}} {\sum }_{n = 0}^{N - 1} {min}_{{\hat{c}}_{n} ∈ Q} {\vert {r}_{n} {ⅇ}^{- {jϕ}_{n}^{\hat{u}}} - {H}_{n} {\hat{c}}_{n} \vert}^{2} \qquad ( 8 )$$

Compared to the decision metric of equation (6) above, it can be seen that the processing burden on the receiver is reduced by a factor γ, where γ is

$$γ = \frac{Operation ( \begin{matrix}{min}_{{P}_{\hat{u}} , \hat{u} ∈ \{ 1 , 2 , … , L \}} {\sum }_{n = 0}^{N - 1} {min}_{{\hat{c}}_{n} ∈ Q} \\ {\vert {r}_{n} {ⅇ}^{- {jϕ}_{n}^{\hat{u}}} - {H}_{n} {\hat{c}}_{n} \vert}^{2}\end{matrix} )}{Operation ( \begin{matrix}{min}_{{P}_{\hat{u}} , \hat{u} ∈ \{ 1 , 2 , … , U \}} {\sum }_{n = 0}^{N - 1} {min}_{{\hat{c}}_{n} ∈ Q} \\ {\vert {r}_{n} {ⅇ}^{- {jϕ}_{n}^{\hat{u}}} - {H}_{n} {\hat{c}}_{n} \vert}^{2}\end{matrix} )} \approx \frac{L}{U} \qquad ( 9 )$$

For example, L/U(=1/K) may be ⅛, which represents a significant reduction in the receiver-side processing burden. Of course, transmitting the sub-block index k from the transmitter 240 to the receiver 250 does involve a signalling overhead. However, the number of bits required to transmit this index k is relatively small, for example three bits. This is a significant reduction compared to the system of FIG. 1 in which the identity u of the selected phase vector is transmitted with full granularity from the transmitter to the receiver. Thus, the third embodiment achieves a lower signalling overhead than the FIG. 1 system without imposing such a high receiver-side processing burden as a comparable system having a completely blind receiver as described previously with reference to FIG. 2. Table 4 below presents a comparison between the systems of FIGS. 1 and 2 and the third embodiment in terms of receiver processing burden and signalling requirements.

TABLE 4

| | Receiver | |
|---|---|---|
| PAPR Reduction | Processing | |
| Techniques | Burden | Signalling Required |
| | Low | Prohibitive |
| | Prohibitive | None |
| Third embodiment | Low | Low |

Using simulations, the performance of the third embodiment was compared with that of (a) an ideal system having a transmitter with infinite amplifier-back-off, (b) a system in which the amplifier has clipping but no PAPR reduction technique, and (c) the system of FIG. 1. The assumptions made for the simulations are set out in Table 5 below.

TABLE 5

| Parameter | Value |
|---|---|
| Total number of subcarriers | 128 |
| Synchronisation | Perfect |
| Modulation | QPSK and 16 QAM |
| Sampling rate | 256 samples per symbol |
| Clipping Level | 2 dB |
| Subcarrier spacing | 19.5 KHZ |
| Channel | AWGN |
| U | 1600 |
| L | 200 |

As can be seen from Table 5, U is assumed to be 1600 and L is assumed to be 200. Thus, K=8. In the case of the system (c), U is also assumed to be 1600. The number of subcarriers is assumed to be 128.

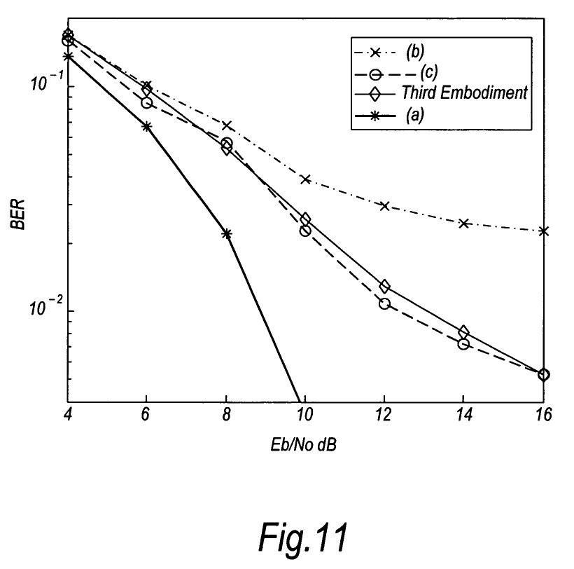

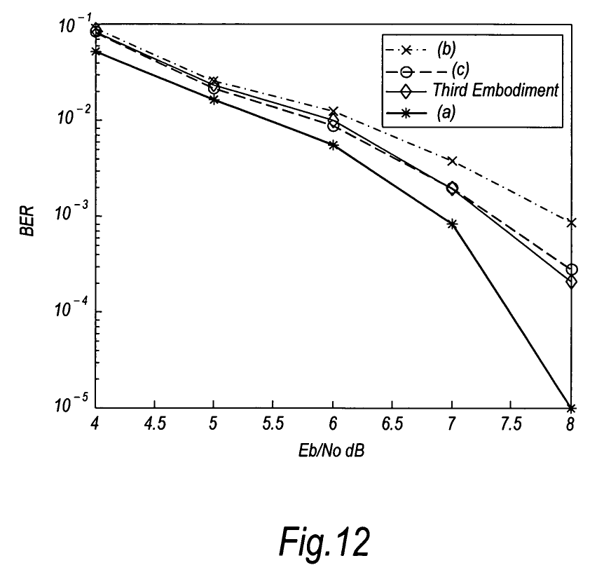

FIG. 11 presents the performance of the compared systems in terms of a variation of the bit error rate (BER) with signal-to-noise ratio (Eb/No) in the case in which the modulation scheme is 16 QAM. FIG. 12 is a graph corresponding to FIG. 11 but comparing the performance of the systems when the modulation scheme is QPSK. It can be seen from FIGS. 11 and 12 that the performance of the third embodiment in terms of BER is quite similar to that of the FIG. 1 system whilst the signalling requirement is eight times less than that of the FIG. 1 system.

The PAPR performance of the third embodiment was also compared with that of the systems (a) and (c) mentioned above. The results are presented in Table 6 below. The PAPR levels in table 8 are the PAPR levels before the soft-limiting non-linear amplifier and were obtained by measuring and averaging over 10,000 independent transmission periods.

TABLE 6

| PAPR Reduction | PAPR |
|---|---|
| Techniques | Level |
| | 5.8055 |
| Third embodiment | 5.8490 |
| No PAPR | 9.1578 |
| Reduction | |

It can be seen that the PAPR reduction achieved by the third embodiment is very close to that of the FIG. 1 system.

It will be appreciated that the features of the embodiments described above may be combined. For example, two or more layers may be defined as in the first embodiment, the set for the first layer having fewer phase vectors than the set for the second layer. When the first layer is selected by the transmitter, the receiver may operate fully blindly, i.e. the transmitter may simply supply the layer index alone to the receiver. The receiver would then search through all U1 phase vectors of the first set to find the selected phase vector. The second set of vectors for layer 2 may be sub-divided into sub-blocks as in the third embodiment. Then, when the second layer is selected, instead of merely sending the layer index, the transmitter may also send the sub-block index k as well. In this way, even though the set of vectors for layer 2 contains many more vectors than the set for layer 1, the processing burden on the receiver is kept manageable because the search is “guided” by the sub-block index.

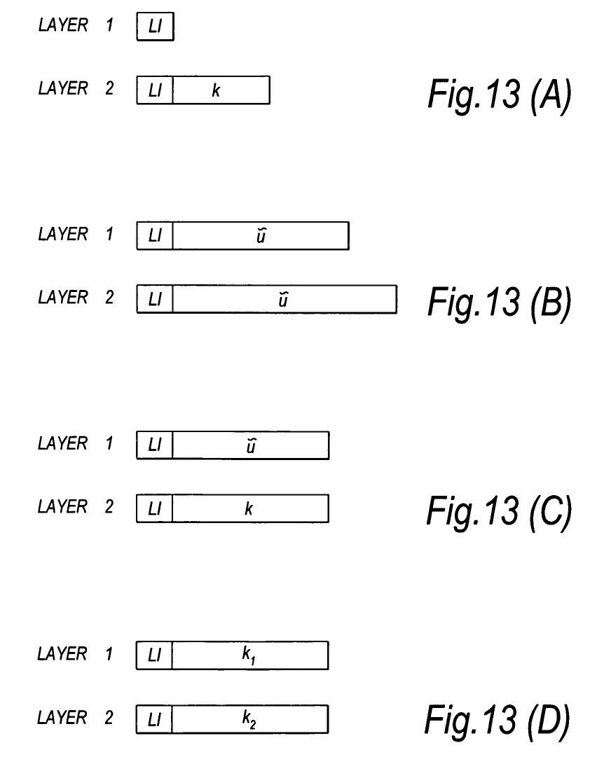

The signalling in such an implementation is shown schematically in FIG. 13(A). It can be seen that the identifying information transmitted by the transmitter to the: receiver is different when layer 1 is selected from the identifying information when layer 2 is selected. In this case the identifying information differs in (a) an amount of the information (1 bit for layer 1 and k+1 bits for layer 2) and in (b) a format of the information (LI alone for layer 1, LI and k together for layer 2) and in (c) in granularity of the information (the lowest possible granularity, i.e. “the entire set”, for layer 1 and a higher granularity, i.e. “one sub-block of the set”, for layer 2). By permitting the identifying information to vary from one layer to another, a system embodying the invention can control the signalling burden associated with the identifying information.

It is not necessary for the identifying information to differ in all of the respects (a) to (c). For example, in the first embodiment in which U1<U2, the identifying information for layer 1 differs from the identifying information for layer 2 in the amount of information (log₂(U1)+1 bits for layer 1 and log₂(U2)+1 bits for layer 2) but the format (LI and U1/U2) and the granularity (the highest possible, i.e. one phase vector uniquely identified) are the same, as shown in FIG. 13(B).

FIG. 13(C) shows another example in which the format and amount of information are the same but the granularity for layer 1 is the highest possible whereas the granularity for layer 2 is lower. This can be useful if, say, it is desirable in the system for the amount of information to be the same for both layers but layer 2 has a set of more phase vectors than layer 1. In FIG. 13(D) the transmitter transmits a layer index and a sub-block index for each of the layers to reduce the processing burden at the receiver. The format and amount of information are again the same for both layers but layer 1 has a first granularity and layer 2 has a second granularity lower than the first granularity. For example, a sub-block index k₁ for layer 1 and a sub-block index k₂ for layer 2 may have the same number of bits by making a number L2 of phase vectors in each sub-block of layer 2 larger than a number L1 of phase vectors in each sub-block of layer 1.

In the embodiments of the invention, the various units, such as the processing unit, may be implemented by a processor such as a DSP running appropriate software. By reducing the processing burden a processor having a lower processing capacity may be used, saving cost. Of course, the units may be implemented in hardware, in which case a reduction in processing burden may enable the amount of hardware to be reduced, also saving cost.

What we claim is:

1. A communication method in which a transmitter transmits a plurality of signals simultaneously to one or more receivers, each said signal carrying data, the method comprising:
at the transmitter, selecting a suitable phase vector from among a plurality of available phase vectors to apply to the plurality of signals, each said available phase vector comprising a plurality of phase elements each of which corresponds to one or more of said signals and sets a phase adjustment to be applied by the transmitter to said corresponding signal(s);
wherein the selection of the suitable phase vector is initially limited to phase vectors belonging to a first set of the available phase vectors within the plurality of available phase vectors, and is expanded to further phase vectors outside said first set when no suitable phase vector is found in said first set.

2. A method as claimed in claim 1, wherein in the selection of the suitable phase vector a suitability of such an available phase vector is based on a peak-to-average power ratio reduction achievable by applying the phase vector concerned to the plurality of signals.

3. A method as claimed in claim 1, wherein the phase vectors of said first set are fewer in number than said further phase vectors outside said first set.

4. A method as claimed in claim 1, wherein the transmitter transmits to the receiver identifying information identifying the selected phase vector, and an amount of said identifying information is smaller when the selected phase vector belongs to the first set than when the selected phase vector is one of said further phase vectors outside said first set.

5. A method as claimed in claim 1, wherein:
the plurality of available phase vectors are organised in a hierarchy of layers, said first set of phase vectors corresponding to a first one of said layers, and there being a second set of phase vectors corresponding to a second one of said layers, and so on for each higher layer, if any, of the hierarchy of layers; and
the selection of the suitable phase vector is expanded from one set to the next in accordance with said hierarchy of layers.

6. A method as claimed in claim 5, wherein the set corresponding to at least one said layer has fewer phase vectors than the set corresponding to a higher layer.

7. A method as claimed in claim 6, wherein said first set has a threshold value for peak-to-average power ratio reduction, and it is judged that there is no suitable phase vector in said first set if none of the phase vectors in said first set is able to achieve a peak-to-average power ratio reduction above said threshold value for said first set.

8. A method as claimed in claim 7, wherein there is such a threshold value for each set other than the set corresponding to the highest layer, and for each set in turn other than the set corresponding to the highest layer it is judged that there is no suitable phase vector in that set if none of the phase vectors in that set is able to achieve a peak-to-average power ratio reduction above said threshold value for that set.

9. A method as claimed in claim 8, wherein the threshold value for the set corresponding to at least one layer is lower than the threshold value for the set corresponding to a higher layer.

10. A method as claimed in claim 7, wherein for at least one set all the phase vectors of the set are considered and the phase vector that is able to achieve the highest peak-to-average power ratio reduction is selected as the suitable phase vector provided that the reduction concerned is above said threshold value for the set.

11. A method as claimed in claim 1, wherein for at least one set the phase vectors of the set are considered sequentially for suitability, and when a first suitable phase vector is found any remaining phase vectors of the set are not considered.

12. A method as claimed in claim 1, wherein the transmitter transmits to the receiver set information for use by the receiver to identify the set to which the selected phase vector belongs.

13. A method as claimed in claim 12, wherein:
the receiver has a plurality of trial phase vectors corresponding respectively to the plurality of available phase vectors of the transmitter; and
the receiver employs the set information to identify the set to which the selected phase vector belongs, and processes the received plurality of signals only with those trial phase vectors that correspond respectively to the available phase vectors of the identified set to recover the data from the received plurality of signals.

14. A method as claimed in claim 1, wherein:
the receiver has a plurality of trial phase vectors corresponding respectively to the plurality of available phase vectors of the transmitter; and
the receiver initially processes the received plurality of signals with those trial phase vectors that correspond respectively to the available phase vectors of the first set of available phase vectors to recover the data from the received plurality of signals, and expands the trial phase vectors to further trial phase vectors corresponding respectively to available phase vectors outside said first set when satisfactory data recovery is not achieved with any of the trial phase vectors that correspond respectively to the available phase vectors of the first set.

15. A method as claimed in claim 1, wherein at least one set is subdivided into a plurality of subsets, and the transmitter transmits to the receiver subset information for use by the receiver to identify the subset to which the selected phase vector belongs.

16. A method as claimed in claim 15, wherein:
the receiver has a plurality of trial phase vectors corresponding respectively to the plurality of available phase vectors of the transmitter; and
the receiver employs the subset information to identify the subset to which the selected phase vector belongs, and processes the received plurality of signals only with those trial phase vectors that correspond respectively to the available phase vectors of the identified subset to recover the data from the received plurality of signals.

17. A transmitter adapted to transmit a plurality of signals simultaneously to one or more receivers, each said signal carrying data, the transmitter comprising:
a phase vector selecting unit which selects a suitable phase vector from among a plurality of available phase vectors to apply to the plurality of signals, each said available phase vector comprising a plurality of phase elements each of which corresponds to one or more of said signals and sets a phase adjustment to be applied by the transmitter to said corresponding signal(s);
wherein the phase vector selecting unit initially limits the selection of the suitable phase vector to phase vectors belonging to a first set of the available phase vectors within the plurality of phase vectors, and expands the selection to further phase vectors outside said first set when no suitable phase vector is found in said first set.

18. A receiver adapted to receive a plurality of signals transmitted simultaneously by a transmitter which applied to the plurality of signals as transmitted a phase vector selected from among a plurality of available phase vectors, each said available phase vector comprising a plurality of phase elements each of which corresponds to one or more of said signals and sets a phase adjustment applied by the transmitter to said corresponding signal(s), and each said signal carrying data, said receiver comprising:
a processing unit which processes the received plurality of signals with trial phase vectors of a plurality of trial phase vectors to recover said data from the received plurality of signals, said plurality of trial phase vectors corresponding respectively to the plurality of available phase vectors of the transmitter;
a receiving unit which receives from the transmitter information for use in identifying a limited set of available phase vectors within the plurality of available phase vectors, said selected phase vector belonging to said limited set; and
a limiting unit which limits said processing by the processing unit to the trial phase vectors that correspond respectively to the available phase vectors of said limited set.

19. A receiver adapted to receive a plurality of signals transmitted simultaneously by a transmitter which applied to the plurality of signals as transmitted a phase vector selected from among a plurality of available phase vectors, each said available phase vector comprising a plurality of phase elements each of which corresponds to one or more of said signals and sets a phase adjustment applied by the transmitter to said corresponding signal(s), and each said signal carrying data, said receiver comprising:
a processing unit which processes the received plurality of signals with trial phase vectors of a plurality of trial phase vectors to recover said data from the received plurality of signals, said plurality of trial phase vectors corresponding respectively to the plurality of available phase vectors of the transmitter;
a limiting unit which limits the processing by said processing unit initially to trial phase vectors of a first set of trial phase vectors within the plurality of trial phase vectors, and which expands the processing to further phase vectors outside said first set if satisfactory data recovery is not achieved with any of the trial phase vectors of said first set.

20. A communication method in which a transmitter transmits a plurality of signals simultaneously to one or more receivers, each said signal carrying data, the method comprising:
at the transmitter, selecting a suitable phase vector from among a plurality of available phase vectors to apply to the plurality of signals, each said available phase vector comprising a plurality of phase elements each of which corresponds to one or more of said signals and sets a phase adjustments to be applied by the transmitter to said corresponding signal(s);
at the receiver, processing the received plurality of signals with trial phase vectors of a plurality of trial phase vectors to recover said data from the received plurality of signals, said plurality of trial phase vectors corresponding respectively to the plurality of available phase vectors of the transmitter;
wherein:
the transmitter transmits to the receiver information identifying a limited set of phase vectors within the plurality of available phase vectors, said selected phase vector belonging to said limited set; and
the receiver identifies said limited set using the received information and limits the trial phase vectors which are processed to recover the data to those trial phase vectors that correspond respectively to the available phase vectors of said limited set.

21. A method as claimed in claim 20, wherein said plurality of available phase vectors are arranged in two or more sets of available phase vectors and said information identifies the set to which the selected phase vector belongs.

22. A method as claimed in claim 21, wherein a first such set has fewer available phase vectors than a second such set.

23. A method as claimed in claim 21, wherein the sets contain the same number of available phase vectors.

24. A method as claimed in claim 21, wherein at least one said set is sub-divided into a plurality of subsets and said information identifies said set and said subset to which said selected phase vector belongs; and
the receiver identifies said set and said subset to which the selected phase vector belongs using the received information and limits the trial phase vectors that are processed to recover the data to those trial phase vectors that correspond respectively to the available phase vectors of the identified subset within the identified set.

25. A method as claimed in claim 20, wherein in the selection of the suitable phase vector a suitability of such an available phase vector is based on a peak-to-average power ratio reduction achievable by applying the phase vector concerned to the plurality of signals.

26. A method as claimed in claim 20, wherein the transmitter considers the phase vectors of the plurality of available phase vectors sequentially for suitability and when a first suitable phase vector is found any remaining available phase vectors are not considered.

27. A method as claimed in claim 20, wherein all of the phase vectors of said plurality of available phase vectors are considered and the phase vector that is able to achieve the highest peak-to-average power ratio reduction is selected as the suitable phase vector.

28. A transmitter adapted to transmit a plurality of signals simultaneously to one or more receivers, each said signal carrying data, the transmitter comprising:
a phase vector selecting unit which selects a suitable phase vector from among a plurality of available phase vectors to apply to the plurality of signals, each said available phase vector comprising a plurality of phase elements each of which corresponds to one or more of said signals and sets a phase adjustment to be applied by the transmitter to said corresponding signal(s); and
a transmitting unit which transmits to the receiver information identifying a limited set of phase vectors within the plurality of available phase vectors, said selected phase vector belonging to said limited set.

29. A communication method in which a transmitter transmits a plurality of signals simultaneously to one or more receivers at a series of times, each said signal carrying data, the method comprising:
at the transmitter, selecting a suitable phase vector from among a plurality of available phase vectors to apply to the plurality of signals transmitted at each of said times, each said available phase vector comprising a plurality of phase elements each of which corresponds to one or more of said signals and sets a phase adjustment to be applied by the transmitter to the corresponding signal(s) transmitted at said time concerned; and
transmitting from the transmitter to the receiver identifying information for use by the receiver to identify the phase vector selected by the transmitter for the transmission of the plurality of signals at each said time;
wherein said identifying information for the transmission at one of said times differs from the identifying information for the transmission at another one of said times in at least one of an amount of said information, a format of said information, and a granularity of said information.

30. A communication method as claimed in claim 29, wherein said plurality of available phase vectors comprise at least first and second sets of available phase vectors, and said identifying information for the transmission at each said time when said selected phase vector belongs to said first set has a first amount of information and said identifying information for the transmission at each said time when said selected phase vector belongs to said second set has a second amount of information different from said first amount.

31. A communication method as claimed in claim 29, wherein said plurality of available phase vectors comprise at least first and second sets of available phase vectors, and said identifying information for the transmission at each said time when said selected phase vector belongs to said first set has a first format and said identifying information for the transmission at each said time when said selected phase vector belongs to said second set has a second format different from said first format.

32. A communication method as claimed in claim 29, wherein said plurality of available phase vectors comprise at least first and second sets of available phase vectors, and said identifying information for the transmission at each said time when said selected phase vector belongs to said first set has a first granularity and said identifying information for the transmission at each said time when said selected phase vector belongs to said second set has a second granularity different from said first granularity.

33. A method as claimed in claim 30, wherein said first set has fewer phase vectors than said second set, and said first amount of information is smaller than said second amount of information.

34. A method as claimed in claim 33, wherein said identifying information identifies the selected phase vector uniquely when the selected phase vector belongs to said first set and when the selected phase vector belongs to said second set.

35. A method as claimed in claim 32, wherein the identifying information merely identifies the set when said selected phase vector belongs to one of said sets.

36. A method as claimed in claim 35, wherein said first set has fewer phase vectors than said second set, and said identifying information merely identifies the set when said selected phase vector belongs to said first set.

37. A method as claimed in claim 32, wherein said first set has fewer phase vectors than said second set, and said identifying information identifies said selected phase vector with a first granularity when the selected phase vector belongs to said first set and with a second granularity, lower than said first granularity, when said selected phase vector belongs to said second set.

38. A method as claimed in claim 37, wherein said identifying information has the same amount of information when the selected phase vector belongs to said first set and when said selected phase vector belongs to said second set.

39. A method as claimed in claim 32, wherein at least one set is sub-divided into a plurality of subsets and when the selected phase vector belongs to that set said identifying information identifies the subset to which the selected phase vector belongs.

40. A method as claimed in claim 29, wherein in the selection of the suitable phase vector a suitability of such an available phase vector is based on a peak-to-average power ratio reduction achievable by applying the phase vector concerned to the plurality of signals.

41. A transmitter adapted to transmit a plurality of signals simultaneously to one or more receivers at a series of times, each said signal carrying data, which transmitter comprises:
a phase vector selecting unit which selects a suitable phase vector from among a plurality of available phase vectors to apply to the plurality of signals transmitted at each of said times, each said available phase vector comprising a plurality of phase elements each of which corresponds to one or more of said signals and sets a phase adjustment to be applied by the transmitter to the corresponding signal(s) transmitted at said time concerned; and
a transmitting unit which transmits from the transmitter to the receiver identifying information for use by the receiver to identify the phase vector selected by the transmitter for the transmission of the plurality of signals at each said time;
wherein said identifying information for the transmission at one of said times differs from the identifying information for the transmission at another one of said times in at least one of an amount of said information, a format of said information, and a granularity of said information.

42. A receiver adapted to receive a plurality of signals transmitted simultaneously by a transmitter at a series of times, each said signal carrying data, and the transmitter having applied to the plurality of signals as transmitted a phase vector selected from among a plurality of available phase vectors, each said available phase vector comprising a plurality of phase elements each of which corresponds to one or more of said signals and sets a phase adjustment applied by the transmitter to said corresponding signal(s) transmitted at said time concerned, said receiver comprising:
an information receiving unit which receives from the transmitter identifying information for use by the receiver to identify the phase vector selected by the transmitter for the transmission of the plurality of signals at each said time;
wherein the received identifying information for the transmission at one of said times differs from the received identifying information for the transmission at another one of said times in at least one of an amount of said information, a format of said information, and a granularity of said information; and
the receiver further comprises:
an identifying information processing unit which processes said identifying information for the transmission at each said time according to its particular said amount, format or granularity of information, as the case may be; and
a data recovery unit which employs the processed identifying information to recover said data from the received plurality of signals.
